(19) United States
(12) Patent Application Publication
(10) Pub. No.: US 2024/0427878 A1
(43) Pub. Date: Dec. 26, 2024

(54) SECURITY DATA SEARCH ENGINE IN A SECURITY MANAGEMENT SYSTEM

(71) Applicant: Microsoft Technology Licensing, LLC, Redmond, WA (US)

(72) Inventors: Anatoliy PANASYUK, Redmond, WA (US); Michael Richard YAGLEY, Kirkland, WA (US)

(21) Appl. No.: 18/340,371

(22) Filed: Jun. 23, 2023

(51) Int. Cl. G06F 21/55

(52) U.S. Cl. CPC G06F 21/552

(57) ABSTRACT

Methods, systems, and computer storage media for providing security posture management using a security data search engine in a security management system. The security management system provides a security data digest that is summary-based index of the security data. The security management system supports a two-stage search strategy using the security data digest and the raw data. In operation, raw data associated with security posture management of a computing environment is accessed. Using the raw data, a security data digest comprising a plurality of summary entities of the raw data is generated. The security data digest is deployed to support generating a security posture of the computing environment. A request is received for the security posture of the computing environment. A security posture visualization that includes at least a summary entity of the security data digest. The security posture visualization is communicated to cause display of the security posture visualization.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, data security posture management (DSPM), cloud security posture management (CSPM) and enterprise security posture management (collectively “security posture management”) can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing security posture management using a security data search engine of a security management system. Security posture management can include analysis of security information and event management (SIEM) that is associated with security alerts generated in computing environment. In particular, the security management system provides a security data digest that is a summary-based index of raw data (e.g., security logs and security data) associated with security posture management. The security management system supports a two-stage search strategy using the security data search engine, the security data digest and the raw data. Based on security search results, security posture management can be provided to support management of security aspects of data, resources, and workloads in computing environments including identifying and remediating risk.

The security data search engine operates to provide security posture management based on generating a security data digest—using raw data—and generating query results using the security data digest or an identified sub-portion of the raw data. The security data search engine operations are executed to generate a plurality of summary entities in the security data digest, where the security data digest operates as a scoping-index for the raw data. The security data digest is deployed to support generating security posture information. For example, a security administrator can request security posture of a computing environment, and the security posture is provided based in part on the security data digest and the summary entities.

Conventionally, security management systems are not configured with a comprehensive computing logic and infrastructure to efficiently search large volumes of security logs and security data in a computing environment. For example, security logs can be indexed to support security investigations; however, in large scale computing environments the accumulated security logs have high storage requirements (i.e., index storage and raw data storage) and compute intensive costs associated with generating the index storage. Such security management systems lack integration with security data search engine operations that improve the storage and retrieval of security data for security posture management.

Merely executing searches on an unindexed storage of logs causes deficient functioning of the security management system. For example, while executing searches, unindexed logs may operate efficiently for narrowly scoped queries (e.g., searches over a short window of time through specific logs for specific clusters/regions). However, not all users are equipped with knowledge to properly scope queries, and any broad queries—intentional or unintentional—become impractical to generate query results (e.g., may take hours or days). Moreover, without an adequate security data search engine solution, investigating security incidents in a computing environment can be tedious and inefficient, and potential threats can become actual threats which can lead to unauthorized access to data and malicious operations in the computing environment.

A technical solution—to the limitations of conventional security management systems—can include the challenge of generating a security data digest based on raw data associated security posture management and employing the security data digest as a summary-based index of the raw data to generate query results—and providing security management operations and interfaces via a security data search engine in a security management system. As such, the security management system can be improved based on security data search engine operations that operate to effectively determine and provide security posture information of a computing environment in a particular manner.

In operation, raw data associated with security posture management of a computing environment is accessed. Using the raw data, a security data digest comprising a plurality of summary entities of the raw data is generated. The summary entities operate as a scoping-index of the raw data. The security data digest associated with generating a security posture of the computing environment is deployed. A request is received for the security posture of the computing environment. A security posture visualization that includes at least a summary entity of the security data digest. The security posture visualization is communicated to cause display of the security posture visualization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system that includes a security data search engine, in accordance with aspects of the technology described herein;

FIG. 1C is a schematic associated with an exemplary security management system that includes a security data search engine, in accordance with aspects of the technology described herein;

FIG. 2A is a block diagram of an exemplary security management system that includes a security data search engine, in accordance with aspects of the technology described herein;

FIG. 2B is a block diagram of an exemplary security management system that includes a security data search engine, in accordance with aspects of the technology described herein;

FIG. 3 provides a first exemplary method of providing security posture management using a security data search engine, in accordance with aspects of the technology described herein;

FIG. 4 provides a second exemplary method of providing security posture management using a security data search engine, in accordance with aspects of the technology described herein;

FIG. 5 provides a third exemplary method of providing security posture management using a security data search engine, in accordance with aspects of the technology described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

A security management system supports management of security aspects of data, resources, and workloads in computing environments. The security management system can help enable protection against threats, help reduce risk across different types of computing environments, and help strengthen a security posture of computing environments (i.e., security status and remediation action recommendations for computing resources including networks and devices). For example, the security management system can provide real-time security alerts, centralize insights for different resources, and provide for preventative protection, post-breach detection, and automated investigation, and response. The security management system can further support providing security posture management with security management operations (e.g., security investigation queries) that support identifying potential threats and actual threats.

Conventionally, security management systems are not configured with a comprehensive computing logic and infrastructure to efficiently search large volumes of security logs and security data in a computing environment. For example, security logs can be indexed to support security investigations; however, in large scale computing environments the accumulated security logs have high storage requirements (i.e., index storage and raw data storage) and compute intensive costs generating the index storage. The volume of security logs from large scale computing environments can be extremely large in size such that using traditional query systems to execute queries on the security logs are ineffective.

Merely executing searches on an unindexed logs in a data store causes deficient functioning of the security management system. For example, while executing searches on unindexed logs can be efficient for narrowly scope queries (e.g., searches over a short window of time through specific logs for specific clusters/regions)—not all users are equipped with knowledge to properly scope queries, and any broad queries—intentional or unintentional—become impractical to generate query results (e.g., may take hours or days). Log data can be unstructured data that is not stored based on an index, which can be difficult to query. Unstructured data—such as security logs—can be converted into structured data and stored in an index. However, because of the volume of log data, the conversion of unstructured data to indexed data needs a significant amount of storage and compute resources. In particular, searches on unstructured data for broad queries (e.g., security management queries for potential security incident information) can be expensive. For example, a security management query and security incident can implicate a small number of machines, during a specific time window-which requires a lot computational resources to identify when the log data is stored without an index.

One way to address search inefficiencies in large scale systems can include selective indexing of the raw data (i.e., unstructured data). Unfortunately, simply selectively indexing the raw data is still computationally expensive and also requires significant storage because for every record of raw data a separate record needs to be created in the index store. For example, a trillion records of raw data would be converted to a trillion records in an index store—albeit of a smaller size than the raw data. As such, a more comprehensive security management system—with an alternative basis for performing security management operations—can improve computing operations and interfaces for securing management.

Embodiments of the present technical solution are directed to systems, methods, and computer storage media, for among other things, providing security posture management using a security data search engine of a security management system. Security posture management can include analysis of security information and event management (SIEM) that are associated with security alerts generated in computing environment. In particular, the security management system provides a security data digest that is a summary-based index of raw data (i.e., security logs and security data) associated with security posture management. The security management system supports a two-stage search strategy using the security data search engine, the security data digest, and the raw data. Based on security search results, security posture management can be provided to support management of security aspects of data, resources, and workloads in computing environments including identifying and remediating risk. Security posture management is provided using the security data search engine that is operationally integrated into the security management system. The security management system supports a security data search engine framework of computing components associated with processing security logs and security data for determining a security posture of a computing environment.

At a high level, a security data search engine is provided to support comprehensive monitoring of a computing environment (e.g., a large-scale system). The security data search engine provides a security data digest as a summarized version of raw data that retains critical elements of the raw data, where the security data digest supports a two-stage search strategy. The two-stage search strategy includes searching over the security data digest to identify summary entities (e.g., time range and nodes) in the security data digest that contains data of interest, and scoped searches over raw data to get more detailed query results. The security data digest can be stored in a data-exploration service and the raw data stored in unstructured data storage.

Security data searches with the security data digest can support different types of functionality in computing environments including threat hunting, incident response, log analysis, compliance monitoring, and threat intelligence analysis. For example, security data searches are conducted to gather and analyze threat intelligence from various external sources. This involves searching through public or private threat intelligence feeds, forums, social media platforms, and other sources to identify emerging threats, new attack techniques, or indicators of compromise relevant to an organization's security posture. As such, security data searches-along with security data searches with embodiments of the present technical solution can play a prominent role in overall security posture of an organization.

By way of illustration, security queries over the security data digest and raw data can be executed to support security investigations. The security data digest can include summary entities including key summary entities based on the raw data. The key summary entities—for example, IP addresses and user or service identities can be configured based on canonical security queries for security investigations. For example, a security query can be based on an IP address associated with an attacker or identities of specific accounts suspected to be compromised. The raw data can include security data-including security logs that are periodically summarized into the security data digest. For a typical security log, such as an audit log or network traffic log, summaries can be generated based on particular time ranges (e.g., hourly, daily, or weekly) during a summarization time period. Summary entities can also include a date, service, region, node, which can be abbreviated versions of their corresponding entries in the raw data.

With the security data digest, the summary entities can be searched via a first search to quickly identify if there exists any activity of interest—first query results—(e.g., communications from a suspect IP address or use of a suspect identity) during a time frame associated with a security query. Based on the security data digest and the first query results, a second search can be executed on the raw data to retrieve detailed logs—second query results—for nodes or services associated with the first query results. The summary entities (e.g., date, service, region, or cluster) can be used as a scoping-index, where a scoping criteria is used to reduce the scope of brute force searches over the raw data. Identified raw data records can be pulled into the data-exploration service (e.g., indexed store) or references can be generated to the raw data records for subsequent analysis. In this way, the security data search engine, the security data digest, and security data search engine operations improve searching across large datasets.

As used herein, the security data digest refers to a condensed or abbreviated version of raw data. The security data digest can specifically be associated with security log data and other types of security data that support performing security management in a security management system. The security data digest is an aggregated summary that can be stored—in some cases periodically updated—with a lot less storage requirements than an index of the raw data. The security data digest can be programmatically generated (e.g., using a security data digest model)—as a scoping index—based on canonical security queries to summarize essential entities of raw data in a concise format that support scoping the raw data for performing security queries of security investigations. Scoping down the total amount of data reduces that data otherwise have been searched, if a security query was executed directly on the raw data. As such, the security data digest operates as a scoping-index of the raw data.

The security data digest includes summary entities that are essential entries in the security data digest that are summaries of the raw data. The security data digest can be used to answer known security queries with summary entities, where the known security queries (i.e., summary entity type operations) can further be answered based on scoped sub-portion of the raw data. In this way, in one implementation, the security data digest may not include references or pointers that are part of a conventional index. Summary entities can be based on summary entity types that correspond to security investigations and security queries (i.e., summary entity type operations). For example, summary entity types can be associated with user account activity, network traffic analysis, malware or intrusion, privilege escalation or unauthorized access, data access and exfiltration, and system and application misconfigurations.

Summary entity types can be associated with one or more summary entities that are part of a record in the security data digest. For example, the user account activity can include summary entities corresponding to a user identity and an IP address. Operationally, an aggregation function can be defined with key summary entities (e.g., time, machine identity, or service) and the security logs are binned based on a time period (e.g., day, week, or month). A summary entity in the security data digest can include multiple fields from the raw data based on a bunch of different techniques (e.g., concatenating, counting, or collapsing) that summarize the raw data into the security data digest.

One or more of these summary entity types can be associated with summary entities that are generated and from the raw data. By way of example, summarizing raw data can be associated with summary entity types that supports performing corresponding operations based on the security data digest and the raw data. The account activity operations include: identify all failed login attempts for a specific user account; determine the IP addresses from which a user account has been accessed; retrieve a user's login history over a specific time period; and find all user accounts that have been locked out in the past 24 hours. The network traffic analysis operations include: identify all inbound connections from a suspicious IP address; investigate network traffic anomalies or spikes in data transfer; identify unauthorized or unusual network protocols or ports being used; and determine the source and destination of a specific network connection.

The malware or intrusion detection operations include: identify all systems affected by a specific malware signature; investigate detected malware or intrusion attempts; find systems with suspicious file modifications or unusual process activity; and determine the extent of a security breach and affected systems. The privilege escalation or unauthorized access operations include: identify users with elevated privileges or recent privilege changes; determine if any user accounts have been granted unauthorized access rights; investigate unusual activity associated with privileged user accounts; and find instances of suspicious user account activities outside of normal working hours. The data access and exfiltration operations include: identify unauthorized access to sensitive files or databases; investigate data exfiltration attempts or unusual data transfer patterns; find instances of large data downloads or exports by specific users; and determine if any data encryption keys or sensitive configuration files have been accessed. And the system and application misconfigurations include: identify system configuration changes made by unauthorized users; investigate misconfigured security settings or permissions; and find instances of unusual application behavior or errors.

The security data digest can be associated with a set of rules (e.g., a security data digest generation model) that support generating the security data digest. The rules can be based on the summary entity types and their corresponding summary entity type operations. An aggregation function can be tuned to different key summary entities to aggregate different types of raw data for the security data digest. The rules (e.g., aggregation function) can identify the different types of raw data and instructions for summarizing the raw data into the summary entities. For example, a rule can indicate that a unique IP address or identity identifier (e.g., user or service) is selected for each record in the security data digest.

Moreover, the rules may further require that duplicate logs based on a time element (e.g., the same action performed at different times) be removed and represented as a single entry that is associated with multiple entries in the raw data. It is contemplated the security data digest can be periodically updated (e.g., security data digest model update engine) with modifications of existing summary entities or new summary entities. For example, based on reviewing different types of security queries executed against the security data digest or the raw data—for example security investigations based on IP addresses and other types of raw data-certain parameters, dimensions, associated with performing the security investigations (e.g., security entity type operations) can be analyzed to identify patterns in the search queries and query results data to support updating summary entities the security data digest.

As such, the security data digest can be a provided as a search index or query index that includes preprocessed or organized security data in a format that supports fast and targeted searching of the security data digest itself and the raw data to more efficiently provide security management. The security data digest is operationally mapped to the raw data to support a two-stage searching feature in a security management system. Executing the security query on both the security data digest and the raw data can be transparent or obscured via a user interface to the user.

By way of illustration, a security query can be first performed on the security data digest and the first query results, the security data digest, and security query can be used to identify a sub-section of the raw data that should be used to execute the security query. For example, a security administrator may investigate a security incident (e.g., security breach) and issue a security query is executed to determine what computing devices were communicating with a known bad actor IP address over a predefined period. Such a security query could yield a large number of records depending on the type of security incident, the length of the breach, and the number of implicated computing devices. However, using the security data digest that includes a single record for the known bad actor IP address, and the record identifies computing devices that communicated with the known bad actor IP address, the security query can more efficiently provide results.

The security query results can be used to find a sub-section of the raw data associated with the known bad actor IP address. In this way, the security digest data, the security query, and the security query results can be used as a scoping condition to identify the sub-section of raw data. For example, a particular time element that is used to create the security data digest (e.g., day, week, or month) can be a parameter in narrowing the scope of raw data that is implicated by the query. Moreover, a security query may be executed on the raw data, and a first set of security search results is generated after 10 minutes. However, the security query can be executed on the security data digest, such that, a revised security query is generated based on the security data digest, and the revised security query is executed on the raw data and a second set of security search results—that is the same to the first set of security search results—generated after 2 minutes.

Advantageously, the embodiments of the present technical solution include several inventive features (e.g., operations, systems, engines, and components) associated with a security management system having a security data search engine. The security data search engine supports security data search engine operations used to generate a security data digest using raw data and generate query results using the security data digest or an identified sub-portion of the raw data—and providing security management operations and interfaces via a security data search engine in a security management system. The security data search engine operations are a solution to a specific problem (e.g., limitations in effective security data searching in large scale systems) in security management. The security data search engine provides ordered combination of operations for generating and deploying a security data digest and using the security data digest and raw data in a two-stage search in a way that improves computing operations in a security management system. Moreover, large amounts security data and logs can be filtered and processed to provide security posture information for applications in a particular manner that improves user interfaces of the security management system.

### Example Systems and Operations

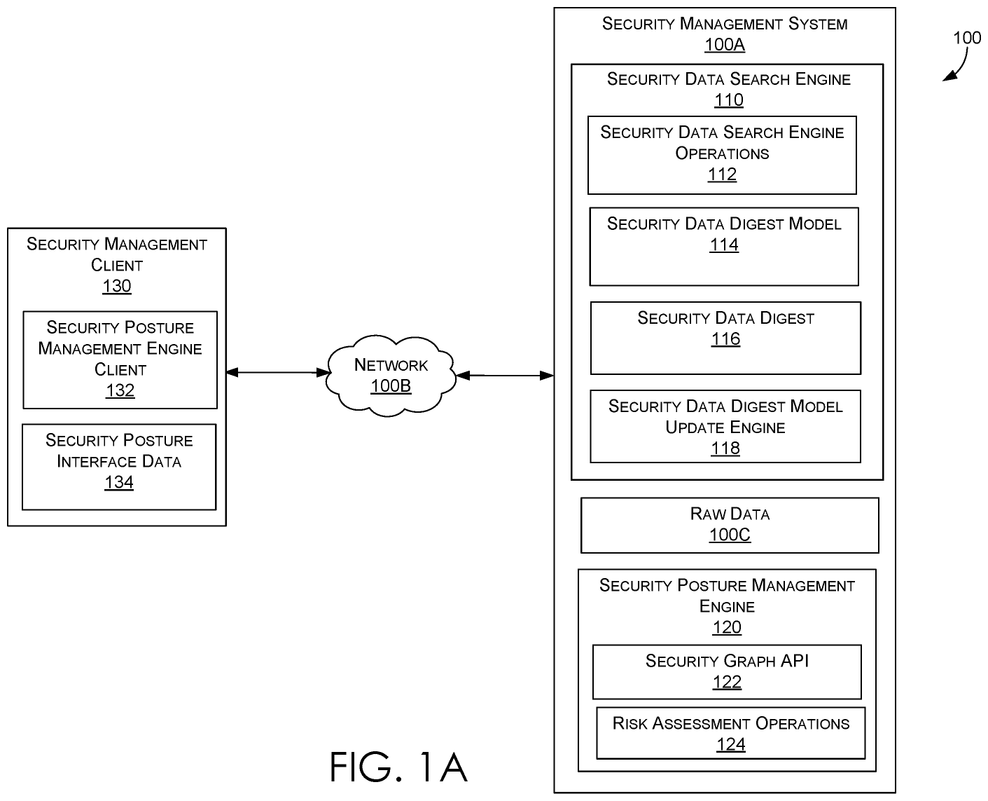

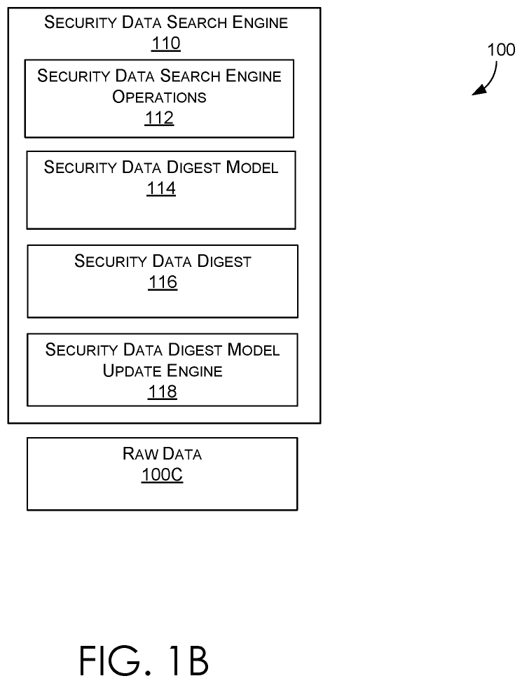

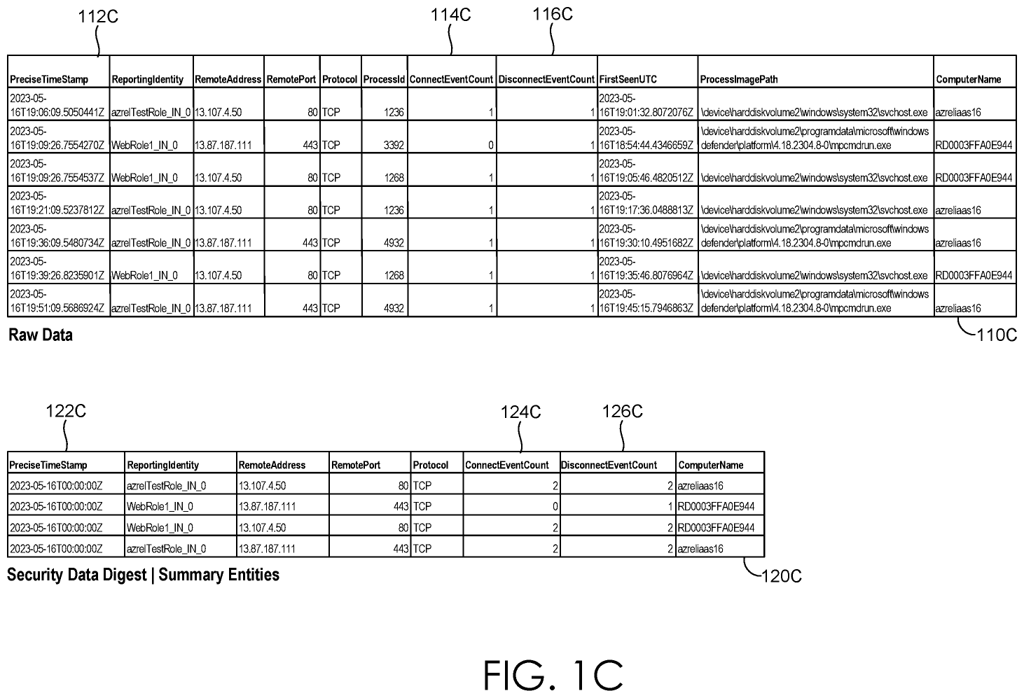

Aspects of the technical solution can be described by way of examples and with reference to FIGS. 1A-1B. FIG. 1A illustrates a cloud computing system (environment) 100 including security management engine 100A; network 100B; raw data 100C; security data search engine 110 having security data search engine operations 112, security data digest model 114, security data digest 116, and security data digest model update engine 118; security management client 130 with security posture management engine 132 and security posture interface data 134; and security posture management engine 120 with security graph API 122 and risk assessment operations 124.

The cloud computing environment 100 provides computing system resources for different types of managed computing environments. For example, the cloud computing environment 100 supports delivery of computing services-including servers, storage, databases, networking, and security intelligence. A plurality of security management clients (e.g., security management client 130) include hardware or software that access resources in the cloud computing environment 100. Security management client 130 can include an application or service that supports client-side functionality associated with cloud computing environment 100. The plurality of security management clients can access computing components of the cloud computing environment 100 via a network (e.g., network 100B) to perform computing operations.

The security management system 100A is designed to provide security management using the security data search engine 110. The security management system 100A provides an integrated operating environment based on a security management framework of computing components associated with providing a security data digest that supports a two-stage search strategy using the search data engine 110, the security data digest 116 and an identified sub-portion of raw data 100C. The security management system 100A integrates security data search engine operations—that support generating a security data digest using raw data and generating query results using the security data digest or an identified sub-portion of the raw data-into security management operations and interfaces to effectively provide security posture investigation information, security posture information, and remediation information for a computing environment. For example, a security administrator can request security posture information of a computing environment, and the security posture information is provided based in part based on the security data digest that includes a plurality summary entities of the raw data.

The security data search engine 110 is responsible for generating the security data digest 116 based on raw data 100C, security data search engine operations 112, security data digest model 114 and the security data digest model update engine. The security data search engine 110 accesses raw data 100C from a plurality of data sources. The data sources can include cloud storage, databases, cloud applications, streaming data, service application and external data sources associated with security posture management. The raw data 100C can be security log data including recorded information that captures activities, events, and incidents related to security in a computing environment. Security log data can further include data retrieved via the security graph API 122. Security log data can support providing a detailed audit trail and evidence of security-related events for monitoring, analysis and investigation purposes. Security log data can be associated with authentication events, authorization events, system events, intrusion detection/prevention systems (IDS/IPS), firewall logs, antivirus/antimalware logs; SIEM logs, audit logs, and security incident logs.

The data sources support retrieving raw data 100C that are associated with different summary entity types that are defined in the security data digest model 114. The data sources are associated with a plurality of computing resources (e.g., virtual machines, storage, databases, tenant, content delivery network, containers, monitoring and analytics, development). The security data search engine 110 can further include a raw data 100C API (not shown) that supports retrieving different types of raw data 100C to generate security data digest 116. The security data search engine 110 deploys the security data digest 116 to support generating security posture information for a computing environment.

The security posture management engine 120 is responsible for communicating with a security management client 130 having the security posture management engine client 132 and the security incident interface data 134. The security posture management engine client 132 supports client-side security management operations for providing security management in the security management system 100. The security posture management engine client 132 supports presenting a security posture visualization—including query results and summary entities—associated with the security data digest 116, and communicating an indication to perform a remediation action associated with query results and summary entities. As such, the security incident interface data 134 can include data associated with the security data search engine 110, and data associated with the security posture management 120 which can be communicated between the security data search engine 110, the security posture management engine 120, and the security management client 130.

The security posture management engine 120 operates to provide visibility to security status of resources in a computing environment. Security posture information can be associated with security data digest 116, network, data, and identity resources of a computing environment. Security posture information can include query results based on security queries for security posture information as described herein. Security posture information can specifically include a first query result—generated based on the security data digest 116; a second query result—generated based on the security data digest 116 and raw data 100C; and summary entities include in the security data digest 116 generated using the security data digest model 114.

The security posture management engine 120 includes a security graph API 122 that provides access to a security graph (not shown) and security graph data. The security graph provides telemetry data associated with a plurality of resources in a computing environment. In particular, the telemetry data can be security data that is associated with security providers in a computing environment. The security graph and security graph API 122 can support integrating security alerts from different security providers via an API connector that streams alerts to the security posture management engine 120. For example, the security data search engine 110 can operate as a security provider for the security posture management engine 120.

The security posture management engine 120 may assess threats and develop risk scores-using risk assessment operations 124 including attack path analysis-associated with threats and attack paths. An attack path analysis can refer to a graph-based algorithm that scans a cloud security graph to identify exploitable paths that attackers may use to breach a computing environment. The attack path analysis exposes attack paths and suggests remediation actions for issues that would break the attack path and prevent a successful breach. In this way, the attack path analysis help address security issues that pose immediate threat with the greatest potential of being exploited in a computing environment. Other variations and combinations of risk assessment operations are contemplated with embodiments of the present disclosure.

A risk associated with query results can used to generate security posture information. In particular, a risk score can refer to a numerical value that represents the level of risk associated with a particular security incident associated with the annotation. It takes into account various factors such as the likelihood of the event occurring and the potential impact of the event if it does occur. The risk score is used to prioritize actions and allocate resources accordingly.

The security posture management engine 120 can further support generating security posture visualizations based on the security posture information including query results and summary entities associated with the security data digest 116. Security posture information can include the query results, which can be provided in combination with attack path analysis, alerts, and other security management information. For example, a security posture visualization can include query results associated with summary entities in the security data digest 116 and query results associated with security logs in raw data 100C. The security posture information can be generated based on query results such that security posture information is prioritized and filtered. A prioritization identifier (e.g., high, medium, low) can be provided in the security posture visualization in combination with an alert associated with a security issue. Alternatively, a notification associated with the security management information, security prioritization information or the alert can be communicated. Other variations and combinations of communications associated with the unsecured credential are contemplated with embodiments described herein.

The security management client 130 can support accessing a security posture visualization and causing display of the security posture visualization. The security management client 130 can include the security posture management engine client 132 that supports receiving the security posture interface data 134 from the security management system 110A and causing presentation of the security posture interface data 134. The security posture interface data 134 can specifically include security posture visualizations associated with the query results of security queries. The secure posture visualization can further include remediation actions associated different alerts-including alerts that are associated with the query results.

The security management client 130 can further support executing a remediation action. In particular, the security posture visualization can include a remediation action for an alert associated with a scanned data item. The security management client 130 can receive an indication to perform the remediation action associated with query results. Based on receiving the indication to execute the remediation action, the security management client 130 can communicate the indication to execute the remediation action to cause execution of the remediation action.

As such, query results and related security posture information are generated based on the security data search engine 110 and provided with remediation actions that can be selected and communicated to cause the remediation action to be performed. The remediation action can address an actual threat or potential threat associated with the query results and corresponding alerts. For example, a remediation action can include off-boarding a computing device, disabling a user, quarantining a file; turning off external email, or running an antivirus scan. Other variations and combinations of security posture visualizations with the security data digest 114 are contemplated with embodiments described herein.

With reference to FIG. 1B, FIG. 1B illustrates security data search engine 110—having security data search engine operations 112, security data digest model 114, security data digest 116, and security data digest model update engine 118.

The security data search engine 110 provides a security data digest model 114 as a computational model that supports generating the security data digest 116. The security data digest model 114 can be associated with operations that are executed to generate the security data digest 116. The computational model is configured to access raw data 100C and generate the security data digest 116 as a condensed version of the raw data 100C for responding to security queries and operating as scoping index for data in raw data 100 for responding to security queries. The computational model supports programmatically summarizing raw data 100C to the security data digest 116. The computational model can also supports summary entity types associated with summary entity type operations that are used for security investigation, such that known security queries as used in generating the security data digest 116 in a manner that summarizes the raw data 100C in the security data digest 116 to support identifying a sub-portion of the raw data 100C for responding to security queries.

The security data search engine 110 generates the security data digest 116 based on a security data digest model update engine 118. In particular, the security data digest model update engine 118 can be periodically update the security data digest 116 using modifications to summary entities or new summary entities in the security data digest 114. The security data digest can be updated using the security data digest model update engine to generate a plurality of update summary entities. The plurality of update summary entities are generated based on a plurality of update summary entity types associated with executed known security queries (and query results) of security investigations associated with the security data digest 116 and the raw data 100C. For example, based on reviewing different types of security queries executed against the security data digest or the raw data—for example security investigations based on IP addresses and other types of raw data—certain parameters, dimensions, associated with performing the security investigations (e.g., security entity type operations) can be analyzed to identify patterns in the search queries and query results data to support updating summary entities the security data digest.

With reference to FIG. 1C, FIG. 1C illustrates a schematic associated with the security data search engine 110 in the security management system 100A. FIG. 1C includes raw data 110C and security data digest 120C. Raw data 110C include—by way of illustration a plurality of fields (e.g., PreciseTimeStamp 112, ConnectEventCount 114C, and DisconnectEventCount 116C). The security data digest 120C can be generated using techniques described herein to include a plurality of summary entities (e.g., PreciseTimeStamp 122C, ConnectEventCount 124C, and DisconnectEventCount 126C). In particular, an aggregation function can be defined to generate the security data digest 120C from raw data 110C. For example, 7 PreciseTimeStamps 112C can be summarized to 4 PreciseTimeStamps 122C, where instances connection events and disconnection events (i.e., ConnectEvenCount 114C and DisconnectEventCount 116C) are collapsed to summed instances of connection events and disconnection events (i.e., ConnectEvenCount 124C and DisconnectEventCount 126C). In particular, connections events associated with reporting identity azrelTestRole_IN_0 can be combined into a single record in the security data digest 120C. The value of PreciseTimeStamp is changed based the recurring period of executing the aggregation function (i.e., daily)—as such, the PreciseTimeStamp is 2023-05-16T00:00:00Z. In addition, one or more columns (e.g., FirstSeenUTC, ProcessImagePath) of raw data are removed from the security data digest. And, as discussed, the security data digest can be used as a scoping index (e.g., PreciseTimeStamp and ReportingIdentity) to identify complete records in the raw data 110C.

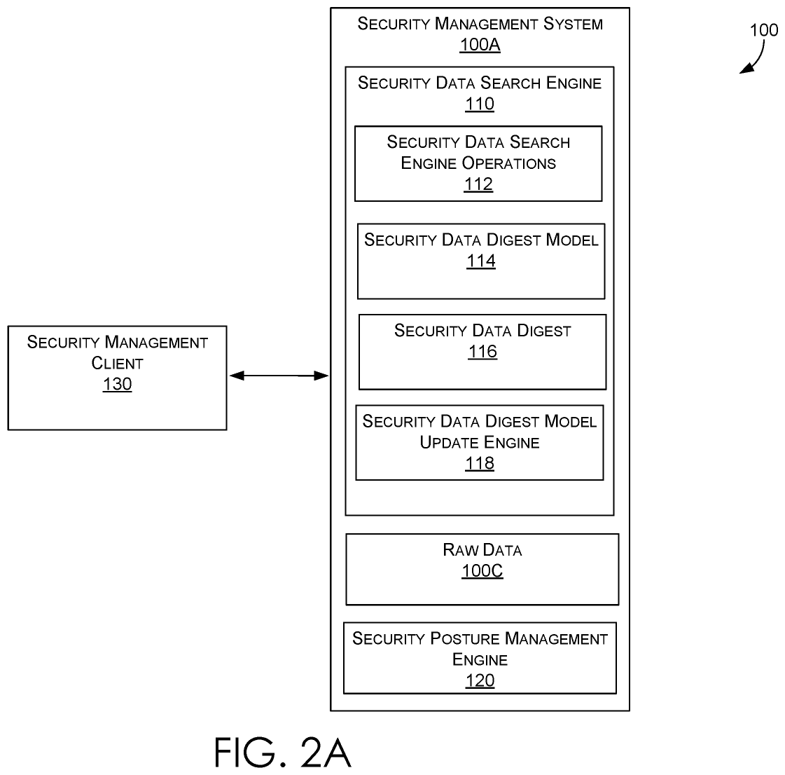

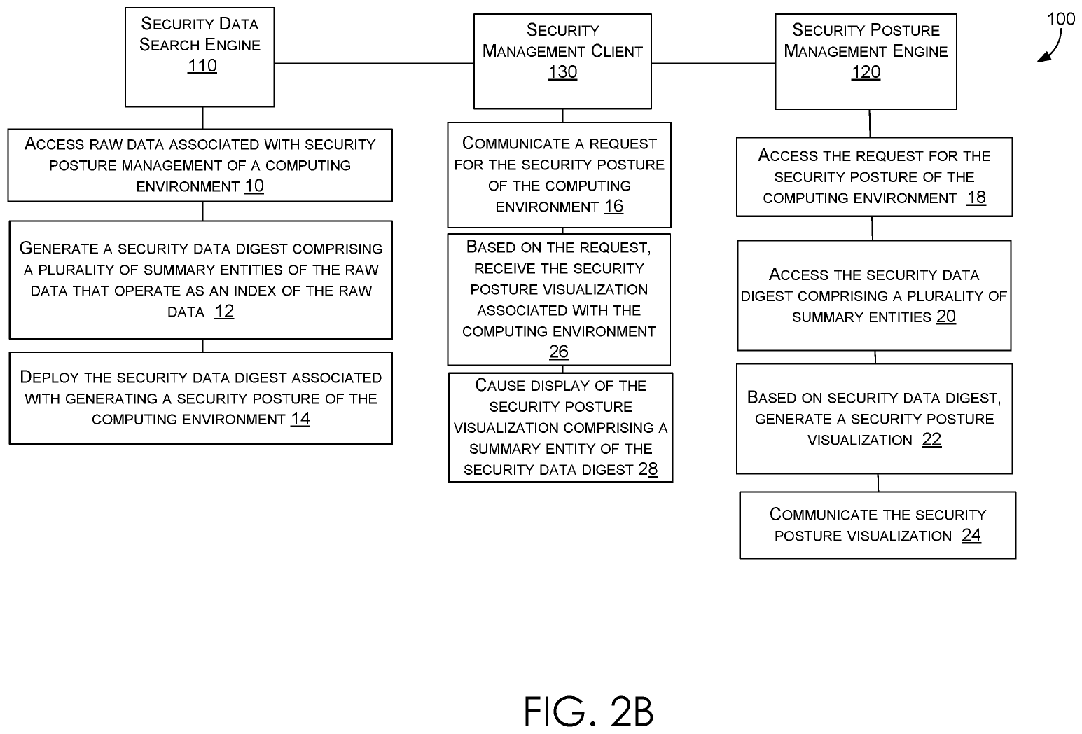

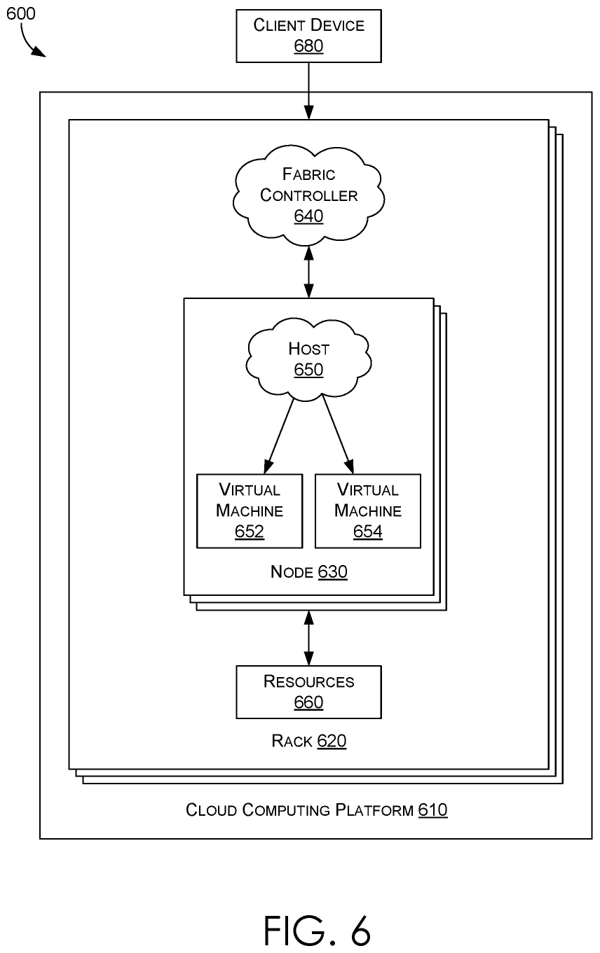

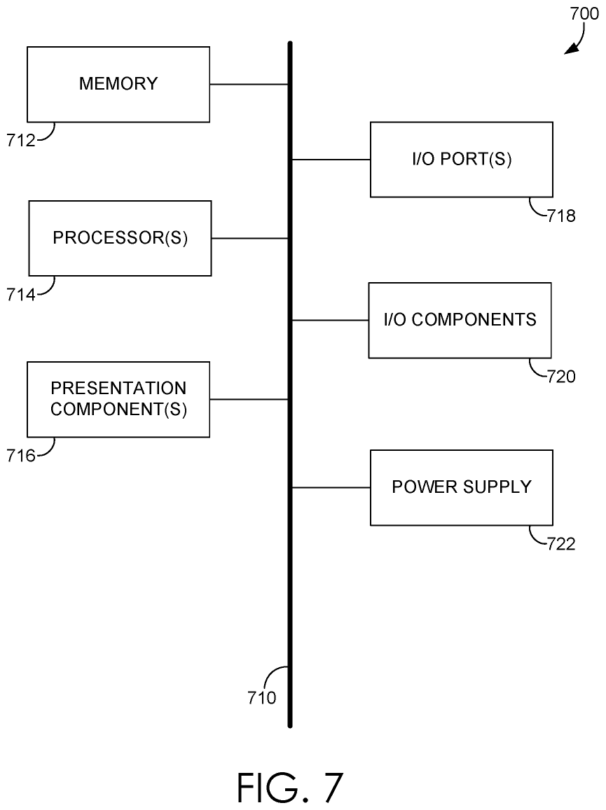

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example security management system 100 in which methods of the present disclosure may be employed. In particular, FIG. 2A shows a high level architecture of the security management system 100A in accordance with implementations of the present disclosure. Among other engines, managers, generators, selectors, or components not shown (collectively referred to herein as “components”), the technical solution environment of security management system 100 corresponds to FIGS. 1A and 1B.

With reference to FIG. 2A, FIG. 2A illustrates a security management system 100A having security management system 100A, security data search engine 110 including security data search engine operations 112, security data digest model 114, application discovery graph 116, and annotated application discovery graph 118; security posture management engine 120, and security management client 130.

The security search engine 110 is responsible for executing or causing executing of a remediation action associated with a security data digest. The security search engine 110 accesses raw data 100C associated with security posture management of a computing environment. The raw data 100C can be stored in an unstructured data storage. Based on accessing the raw data, the security search engine 110 generates the security data digest 116. The security data digest 116 includes a plurality of summary entities of the raw data 100C that operate as a scoping-index of the raw data. Generating the security data digest 116 is based on an aggregation function comprising two or more key summary entities associated with identifying a sub-portion of the raw data for executing queries. Generating the security data digest 116 can also be based on a security data digest model. The security data digest model 114 can be used to generate the plurality of summary entities, where the plurality of summary entities are generated based on a plurality of summary entity types associated with security queries (e.g., summary entity type operations) of known security investigations. The security data digest 116 can be stored in a data exploration service.

A security data digest model update engine 118 is responsible for updating the plurality of summary entities. The security data digest model update engine 118 includes update summary entity types associated with executed search queries and query results on the security data digest 116 and the raw data 100C.

The security posture management engine 120 is responsible for executing security queries and generating security posture visualizations. The security posture management engine 120 accesses a security query associated with the security data digest 116. The security posture management engine 120 executes the security query using the security data digest 116 and generates a first query result for the security query. The first query result comprises a summary entity. Using the first query result, the security posture management engine 120 generates the security posture visualization.

The security posture management engine 120 can further access the security query, the security data digest 116, and the first query result to identify a sub-portion of the raw data 100C for executing the security query. Using the sub-portion of the raw data, the security posture management engine 120 generates a second query result for the security query. Using the second query result, the security posture management engine 102 generates a security posture visualization. In this way, the security posture visualization can be associated with the first query generated using the security data digest 116 and the second query result generated using the security data digest 116 and an identified sub-portion of the raw data 100C. The security posture visualization further includes an alert associated with a summary entity, where the alert is associated with a prioritization identifier and a remediation action. The prioritization identifier can be based on the summary entity and the remediation action can be executed to address a security threat associated with the alert.

A security management client 130 can communicate a request for the security posture of a computing environment. Based on the request, the security management client 130 receives a security posture visualization associated with the computing environment, where the security posture visualization comprises the summary entity that is associated with the security data digest 116. The security management client 130 causes display of the security posture visualization comprising the summary entity.

With reference to FIG. 2B, FIG. 2B illustrates a security management system 100A having security data search engine 110, security management client 130, and security posture management engine 120. At block 10, the security data search engine 110 accesses application raw data associated with security posture management of a computing environment; at block 12, generates a security data digest comprising a plurality of summary entities of the raw data that operate as a scoping-index of the raw data; and at block 14, deploys the security data digest to support generating a security posture the computing environment. At block 16, the security management client 130 communicates a request for the security posture of the computing environment.

At block 18, the security posture management engine, accesses the request for the security posture of the computing environment; at block 20, accesses the security data digest comprising a plurality of summary entities; at block 22, based on the security data digest, generates a security posture visualization; and at block 24 communicates the security posture visualization. At block 26, the security management client 130, based on the request, receives the security posture visualization associated with the computing environment; and at block 28, causes display of the security posture visualization comprising a summary entity of the security data digest.

### Example Methods

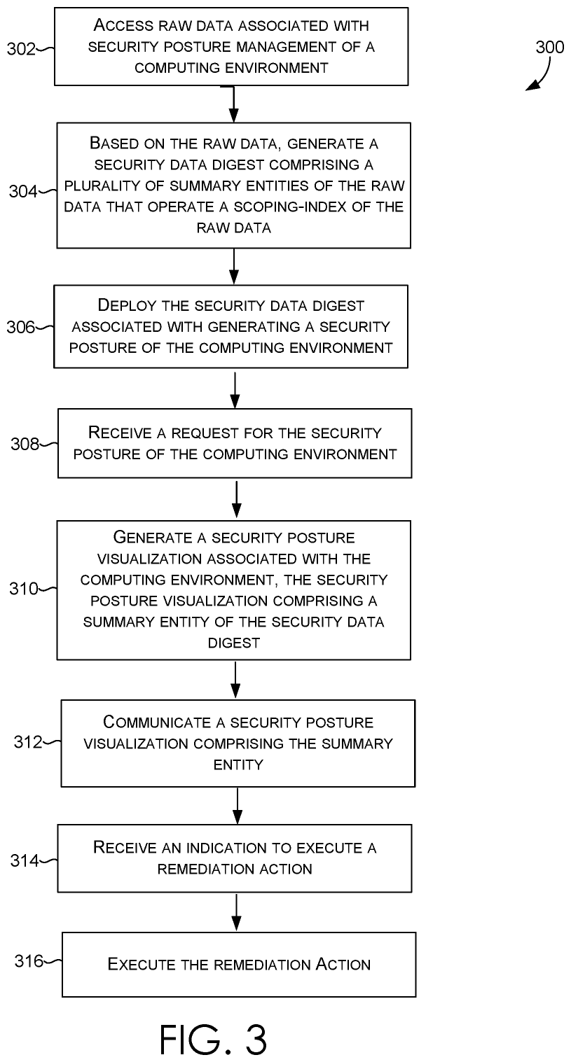

With reference to FIGS. 3, 4, and 5, flow diagrams are provided illustrating methods for providing security posture management using a security data search engine in a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system or computing system).

Turning to FIG. 3, a flow diagram is provided that illustrates a method 300 for providing security posture management using a security data search engine in a security management system. At block 302, raw data associated with security posture management of a computing environment is accessed. At block 304, based on the raw data, a security data digest comprising a plurality of summary entities of the raw data that operate as a scoping-index of the raw data are generated. At block 306, the security data digest is deployed to support generating a security posture of the computing environment. At block 308, a request for the security posture of the computing environment is received. At block 310, a security posture visualization associated with the computing environment is generated, where the security posture visualization comprises a summary entity of the security data digest. At block 312, a security posture visualization is communicated to cause display of the security posture visualization comprising the summary entity. At block 314, an indication is received to execute a remediation action. At block 316, the remediation action is executed.

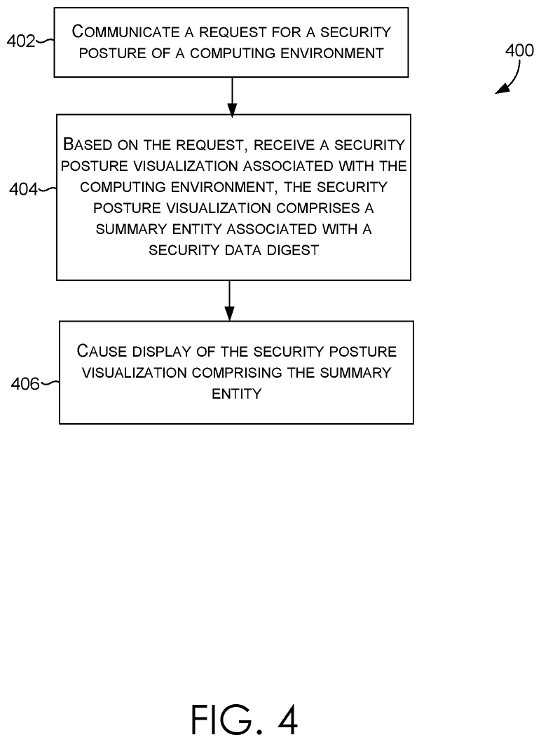

Turning to FIG. 4, a flow diagram is provided that illustrates a method 400 for providing security posture management using a security data search engine in a security management system. At block 402, a request for a security posture of a computing environment is communicated. At block 404, based on the request, a security posture visualization associated with the computing environment is received, the security posture visualization comprises a summary entity associated with a security data digest. At block 406, the security posture visualization comprising the summary entity is caused to be displayed.

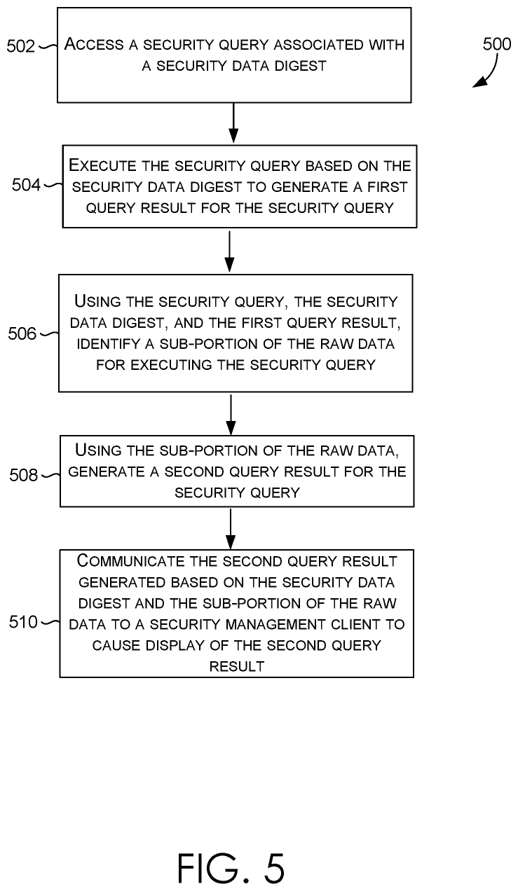

Turning to FIG. 5, a flow diagram is provided that illustrates a method 500 for providing security posture management using a security data search engine in a security management system. At block 502, a security query associated with a security data digest is accessed. At block 504, the security query is executed based on the security data digest. The security query is executed to generate a first query result for the security query. At block 506, using the security query, the security data digest, and the first query result, a sub-portion of raw data for executing the security query is identified. At block 508, using the sub-portion of the raw data, a second query results is generated the security query. At block 510, the second query result—that is generated based on the security data digest and the sub-portion of the raw data—is communicated to a security management client to cause display of the second query result.

### Technical Improvement

Embodiments of the present technical solution have been described with reference to several inventive features (e.g., operations, systems, engines, and components) associated with a security management system. Inventive features described include: operations, interfaces, data structures, and arrangements of computing resources associated with providing the functionality described herein relative with reference to a security data search engine. Functionality of the embodiments of the present technical solution have further been described, by way of an implementation and anecdotal examples—to demonstrate that the operations (e.g., generating a security data digest using raw data and generating query results using the security data digest or an identified sub-portion of the raw data based on security data search engine operations) for providing the security data search engine. The security data search engine is as a solution to a specific problem (e.g., limitations in effective security data searching in large scale systems) in security management technology. The security data search engine improves computing operations associated with security investigations and providing security posture information in security management systems. Overall, these improvements result in less CPU computation, smaller memory requirements, and increased flexibility in security management systems when compared to previous conventional security management system operations performed for similar functionality.

### Additional Support for Detailed Description

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) running a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present technical solution, an example operating environment in which embodiments of the present technical solution may be implemented is described below in order to provide a general context for various aspects of the present technical solution. Referring initially to FIG. 6 in particular, an example operating environment for implementing embodiments of the present technical solution is shown and designated generally as computing device 600. Computing device 600 is but one example of a suitable computing environment and is not intended to suggest any limitation as to the scope of use or functionality of the technical solution. Neither should computing device 700 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations, the operations comprising:
accessing raw data associated with security posture management of a computing environment;
based on the raw data, generating a security data digest comprising a plurality of summary entities of the raw data that operate as a scoping-index of the raw data;
deploying the security data digest associated with generating a security posture of the computing environment;
receiving a request for the security posture of the computing environment;
using the security data digest, generating a security posture visualization associated with the computing environment, wherein the security posture visualization comprises a summary entity of the security data digest;
communicating the security posture visualization comprising the summary entity;
receiving an indication to execute a remediation action associated with the summary entity, wherein the remediation action is associated with the security posture visualization; and
executing the remediation action.

2. The system of claim 1, further comprising causing display of the security posture visualization comprising the summary entity.

3. The system of claim 1, wherein generating the security data digest is based on an aggregation function comprising two or more key summary entities associated with identifying a sub-portion of the raw data for executing security queries, wherein the security data digest is stored in a data exploration service and the raw data is stored as unstructured data in an unstructured data storage.

4. The system of claim 1, wherein generating the security data digest comprises using a security data digest model to generate the plurality of summary entities, the plurality of summary entities are generated based on a plurality of summary entity types associated with known security queries of security investigations.

5. The system of claim 1, further comprising a security data digest model update engine associated with periodically updating the plurality of summary entities, wherein the security data digest model update engine comprises update summary entity types associated with executed search queries and query results on the security data digest and the raw data.

6. The system of claim 1, wherein generating the security posture visualization comprises:
accessing a security query associated with the security data digest;
executing the security query using the security data digest;
generating a first query result for the security query, wherein the first query result comprises the summary entity; and
using the first query result, generating the security posture visualization.

7. The system of claim 1, wherein generating the security posture visualization comprises:
accessing a security query associated with the security data digest;
executing the security query using the security data digest;
generating a first query result for security;
based on the first query result, determining to execute the security query using the raw data;
using the security query, the security data digest, and the first query result, identifying a sub-portion of the raw data for executing the security query;
using the sub-portion of the raw data, generating a second query result for the security query; and
using the second query result, generating the security posture visualization.

8. The system of claim 1, the operations further comprising:
communicating the request for the security posture of the computing environment;
based on the request, receiving the security posture visualization associated with the computing environment, wherein the security posture visualization comprises the summary entity that is associated with the security data digest; and
causing display of the security posture visualization comprising the summary entity.

9. The system of claim 1, wherein the security posture visualization is associated with a first query result generated using the security data digest and a second query result generated using the security data digest and an identified sub-portion of the raw data.

10. The system of claim 1, wherein the security posture visualization comprises an alert associated with the summary entity, wherein the alert is associated with a prioritization identifier and the remediation action, wherein the prioritization identifier is based on the summary entity and the remediation action is executable to address a security threat associated with the alert.

11. One or more computer-storage media having computer-executable instructions embodied thereon that, when executed by a computing system having a processor and memory, cause the processor to perform operations, the operations comprising:
communicating a request for a security posture of a computing environment;
based on the request, receiving a security posture visualization associated with the computing environment, wherein the security posture visualization comprises a summary entity of a security data digest; and
causing display of the security posture visualization comprising the summary entity.

12. The media of claim 11, the operations further comprising:
accessing raw data associated with security posture management of the computing environment;
based on the raw data, generating the security data digest comprising a plurality of summary entities of the raw data that operate as a scoping-index of the raw data; and
deploying the security data digest to support generating the security posture of the computing environment.

13. The media of claim 11, the operations further comprising:
accessing a security query associated with the security data digest;
executing the security query using the security data digest;
generating a first query result for security, wherein the first query result comprises the summary entity; and
using the first query result, generating the security posture visualization.

14. The media of claim 11, the operations further comprising:
accessing a security query associated with the security data digest;
executing the security query using the security data digest;
generating a first query result for security;
based on the first query result, determining to execute the security query using the raw data;
using the security query, the security data digest, and the first query result, identifying a sub-portion of the raw data for executing the security query;
using the sub-portion of the raw data, generating a second query result for the security query; and
using the second query result, generating the security posture visualization.

15. The media of claim 11, the operations further comprising:
receiving an indication to execute a remediation action associated with the summary entity, wherein the remediation action is associated with the security posture visualization; and
communicating the indication to execute the remediation action to cause execution of the remediation action.

16. A computer-implemented method, the method comprising:
accessing raw data associated with security posture management of a computing environment;
based on the raw data, generating a security data digest comprising a plurality of summary entities of the raw data that operate as a scoping-index of the raw data; and
deploying the security data digest associated with generating a security posture of the computing environment.

17. The method of claim 16, wherein generating the security data digest comprises using a security data digest model to generate the plurality of summary entities, the plurality of summary entities are generated based on a plurality of summary entity types associated with security queries of known security investigations.

18. The method of claim 16, further comprising:
receiving a request for the security posture of the computing environment;
using the security data digest, generating a security posture visualization associated with the computing environment, wherein the security posture visualization comprises a summary entity of the security data digest; and
communicating the security posture visualization to cause display of the security posture visualization comprising the summary entity.

19. The method of claim 18, wherein generating the security posture visualization comprises:
accessing a security query associated with the security data digest;
executing the security query using the security data digest;
generating a first query result for security, wherein the first query result comprises the summary entity; and
using the first query result, generating the security posture visualization.

20. The method of claim 18, wherein generating the security posture visualization comprises:
accessing a security query associated with the security data digest;
executing the security query using the security data digest;
generating a first query result for security;
based on the first query result, determining to execute the security query using the raw data;
using the security query, the security data digest, and the first query result, identifying a sub-portion of the raw data for executing the security query;
using the sub-portion of the raw data, generating a second query result for the security query; and
using the second query result, generating the security posture visualization.
